(19) United States
(12) Patent Application Publication
(10) Pub. No.: US 2010/0130029 A1
(43) Pub. Date: May 27, 2010

(54) BUILDING ENTRANCE PROTECTOR HAVING PRINTED CIRCUIT BOARD AND FUSIBLE LINK

(76) Inventor: Doug Williams, Omaha, NE (US)

Correspondence Address: CommScope by Muncy, Geissler, Olds & Lowe, PLLC, P.O. Box 1364, Fairfax, VA, 22038, US

(21) Appl. No.: 12/275,438

(22) Filed: Nov. 21, 2008

(51) Int. Cl. H01R 12/00; H01R 43/20

(52) U.S. Cl. 439/65; 29/747

(57) ABSTRACT

A building entrance protector for interconnecting wire entering a building from outside the building with wire inside the building which building entrance protector includes a printed circuit board, a protector panel mounted on and electrically connected to the printed circuit board, an input termination connector connectable to the wire entering the building and electrically connected to the protector panel by a fusible link formed on the printed circuit board, and an output termination connector connectable to the wire inside the building and electrically connected to the printed circuit board.

### FIELD OF THE INVENTION

The present invention is directed to a building entrance protector having a printed circuit board and a fusible link and to a method of forming same, and, more specifically, toward a building entrance protector having input and output termination openings electrically connected to a printed circuit board, a protector panel electrically connected to the printed circuit board, and a fusible trace on the printed circuit board between the input termination openings and the protector panel and toward a method of forming same.

### BACKGROUND OF THE INVENTION

A building entrance protector (BEP) is a junction box in which telephone lines from outside a building are joined to customer premises equipment. For example, the BEP may be the place where telephone lines from a telephone pole enter a building and are joined to the telephone system within that building. Inside the BEP there is an input wire termination connector that receives the telephone lines from outside the building and an output termination connector that connects to the telephone lines from inside the building. The BEP also generally includes a protector panel, such as a surge protector, to substantially isolate the telephone system inside the building from voltage and current spikes from the outside wiring. In addition to such protectors, it is known to provide fusible links in the form of small-gauge wires between the input wire termination connectors and the protector panel to protect against very large power surges, such as those caused by lightning strikes or a power line coming into contact with the telephone line. These fusible links cannot carry high currents and therefore melt when such currents are present thereby opening a circuit and protecting the interior telephone equipment from damage.

It is known to interconnect input termination connectors, protector panels and output termination connectors using wire wrapping. With this method, pins on each device are connected to pins on other devices by winding exposed ends of wires around each pin to make the necessary connections. It is also known in the art that electrical connections can be made through the use of traces on a printed circuit board. Such a method is disclosed, for example, in U.S. Pat. No. 5,457,593 to Glaser, the disclosure of which is hereby incorporated by reference in its entirety. Using a printed circuit board simplifies the connections among elements and reduces the labor required for assembling a building entrance protector. However, by making connections through a printed circuit board instead of using individual wires, the ability to provide fusible links as discussed above may be lost. This may leave the telephone system within a building exposed to power surges from outside the building. It would therefore be desirable to provide a building entrance protector that employs a printed circuit board for easier interconnection of building entrance protector elements and that also provides fusible links to protect telephone equipment connected to the building entrance protector.

### SUMMARY OF THE INVENTION

These problems and others are addressed by the present invention, a first aspect of which comprises a building entrance protector for interconnecting wire entering a building from outside the building with wire inside the building. The building entrance protector includes a printed circuit board, an input termination connector connectable to wire entering the building and electrically connected to the printed circuit board, an output termination connector connectable to wire inside the building and electrically connected to the printed circuit board and a protector panel electrically connected to the printed circuit board. The printed circuit board includes a first trace electrically connecting the input termination connector and the protector panel and a second trace electrically connecting the protector panel and the output termination, and the resistance of the first trace is greater than the resistance of the second trace.

Another aspect of the invention comprises a method of connecting wire entering a building from outside the building with wire inside the building which method includes: providing a printed circuit board, electrically connecting an input termination connector to the printed circuit board, electrically connecting an output termination connector to the printed circuit board and electrically connecting a protector panel connected to the printed circuit board. The method also includes forming a first trace on the printed circuit board, having a first resistance, electrically connecting the input termination connector to the protector panel, and forming a second trace on the printed circuit board, having a second resistance less than the first resistance, electrically connecting the protector panel to the output termination connector.

A further aspect of the invention includes a building entrance protector for interconnecting wire entering a building from outside the building with wire inside the building which building entrance protector includes a printed circuit board, a protector panel mounted on and electrically connected to the printed circuit board, an input termination connector connectable to the wire entering the building and electrically connected to the protector panel by a fusible link formed on the printed circuit board and an output termination connector connectable to the wire inside the building and electrically connected to the printed circuit board.

Another aspect of the invention comprises a building entrance protector for interconnecting wire entering a building from outside the building with wire inside the building, where the building entrance protector includes a housing having a first group of openings comprising input openings, a second group of openings comprising output openings and a third group of openings comprising protector openings. The BEP also includes a printed circuit board having a first group of vias comprising input vias, a second group of vias comprising output vias and a third group of vias comprising protector vias. The building entrance protector includes a surge protector having a plurality of pins that extend though the third group of openings and are electrically connected to the third group of vias. The printed circuit board further includes a first set of traces electrically connecting the first group of vias to the third group of vias and a second set of traces electrically connecting the third group of vias to the second set of vias, and the resistance of the traces in the first set of traces is greater than the electrical resistance of the traces of the second set of traces.

### BRIEF DESCRIPTION OF THE DRAWINGS

These aspects and features of the invention and others will be better understood after a reading of the following detailed description of presently preferred embodiments of the invention together with the attached drawings wherein:

FIG. 1 is a side elevational view of a building entrance protector including a printed circuit board according to an embodiment of the present invention;

FIG. 2 is a sectional elevational view taken through line II-II in FIG. 1;

FIG. 3 is a top plan view of the building entrance protector of FIG. 1 with a cover removed to show the printed circuit board; and

FIG. 4 is a top plan view of a portion of a printed circuit board from a building entrance protector according to a second embodiment of the present invention.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

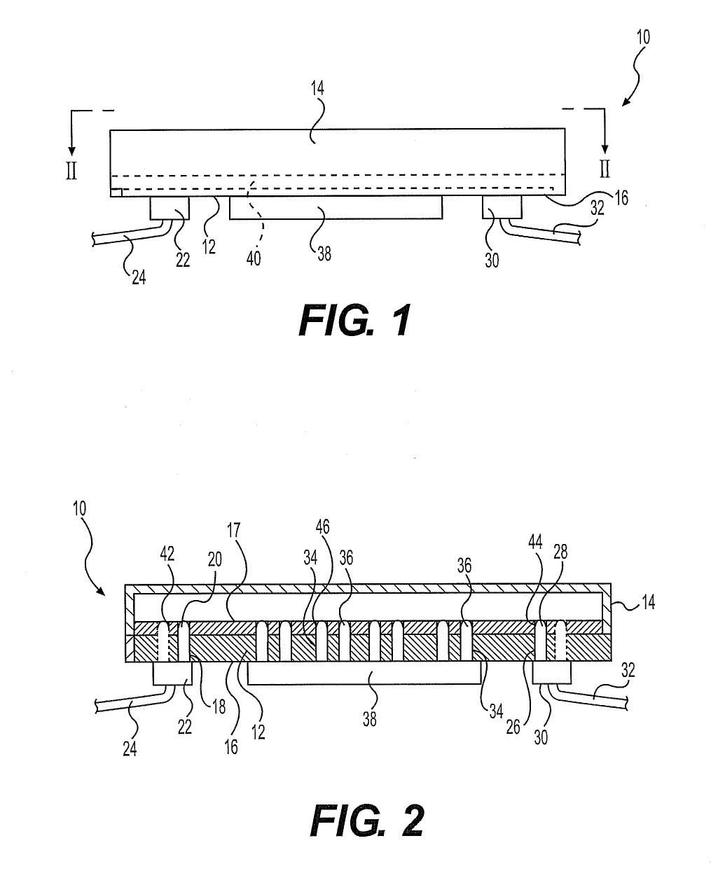

Referring now to the figures, FIGS. 1 and 2 illustrate a building entrance protector 10 comprising a housing formed of a body member 12 and a cover 14 removably or hingedly mounted on the body member 12. Body member 12 includes an outer surface 16, an inner surface 17, and a first plurality of openings 18 for receiving input pins 20 of input connectors 22 which are in turn connected to wires 24 arriving at a building (not illustrated) from outside the building. Body member 12 further includes a second plurality of openings 26 for receiving output pins 28 of output connectors 30 which are connected to wires 32 that lead to the telephone system inside a building. Body member 12 also includes a third plurality of openings 34 for receiving protector pins 36 of a protector panel 38 which may comprise, for example, a surge protector. Input pins 20, output pins 28 and protector pins 36 are all sufficiently long that they extend through body member 12 and past body member inner surface 17.

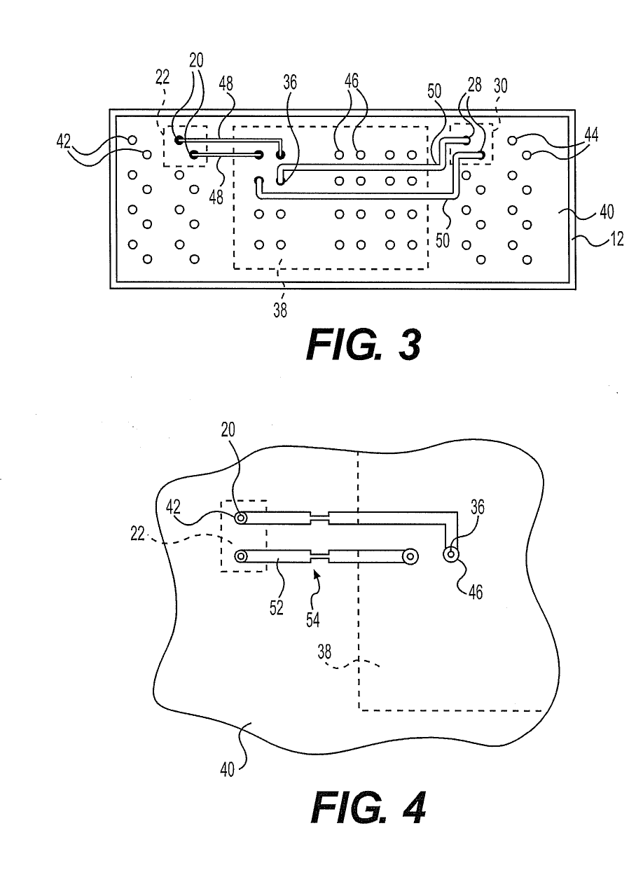

A printed circuit board 40, illustrated for example in FIG. 3, is mounted on inner surface 17 of body member 12 and includes a first plurality of vias 42 aligned with first plurality of openings 18, a second plurality of vias 44 aligned with second plurality of openings 26 and a third plurality of vias 46 aligned with third plurality of openings 34 on body member 12. Each of the first, second and third plurality of vias 42, 44 and 46 is plated with metal in order to form an electrical connection with a pin inserted therein. Input traces 48 connect various ones of the first plurality of vias 42 to appropriate ones of the second plurality of vias 44 in order to electrically connect input pins 20 of input connectors 22 to protector pins 36 of protector panel 38, and output traces 50 are provided on the printed circuit board 40 to connect protector pins 36 of protector panel 38 to output pins 28 of output connectors 30. Only one input connector 22 and one output connector 30 are illustrated in the drawing figures, and likewise, only one set of input traces 48 and one set of output traces 50 are shown for purposes of illustration. Those of ordinary skill in this field will appreciate that a suitable arrangement of input traces 48 and output traces 50 will be provided to connect an appropriate number of input connectors 22 and output connectors 30 to protector panel 38 and to connect the various pins of the input connector, protector panel and output connecter in the same manner that connector pins were conventionally connected using individual wires.

Input traces 48 are formed to have a greater electrical resistance than output traces 50. This may be accomplished, for example, by making the cross section of the input traces 40 less than the cross section of the output traces 50 as illustrated in FIG. 3. If the input and output traces are formed with the same thickness, for example, the width of the input traces 48 will be less than that of the output traces 50. Alternately, the input traces 48 could be formed to have a greater length than the length of the output traces to increase their resistance, or the input traces could be formed of a material having a resistivity greater than the resistivity of the material used to form the output traces so that even with comparable cross sections, the resistance of the input traces would be greater than the resistance of the output traces 50. In one embodiment of the invention, for example, input traces 48 could be about six inches long and formed from 0.161 grams of copper while output traces 50 of the same length could be formed of 0.257 grams of copper to provide the input traces 48 with a greater resistance than the output traces 50 by a factor of 1.6, for example. With this arrangement, if outside wires 24 come into contact with a power line or are struck by lightning, the high current will fuse the thin input traces 48 and substantially prevent dangerously high currents from reaching inside wires 32. In this manner, the benefits of using fusible links in the form of individual small-gauge wires in a wire-wrapping arrangement can be realized when a printed circuit board is used to interconnect the elements of a BEP.

A second embodiment of the present invention is illustrated in FIG. 4 wherein like reference numerals are used to show elements common to the first embodiment. In this embodiment, input traces 52 have generally the same cross section as output traces 50 over most of their length but are provided with narrowed fusible regions 54 having a smaller cross section than the cross section of the rest of the input traces 52. This configuration may allow similar benefits as input traces 48 of the first embodiment, but will also control the location on the input trace where a fusing will occur and thus allow an operator to readily determine whether any of the traces have fused by examining a smaller area of the printed circuit board.

The present invention has been described herein in terms of several presently preferred embodiments. However, additions and modifications to these embodiments will become apparent to those of ordinary skill in the relevant art upon a reading of the foregoing description. It is intended that all such improvements and additions form a part of the present invention to the extent they fall within the scope of the several claims appended hereto.

What is claimed is:

1. A building entrance protector for interconnecting wire entering a building from outside the building with wire inside the building, the building entrance protector comprising:
a printed circuit board;
an input termination connector connectable to the wire entering the building and electrically connected to the printed circuit board;
an output termination connector connectable to the wire inside the building and electrically connected to the printed circuit board; and
a protector panel electrically connected to the printed circuit board;
the printed circuit board including a first trace electrically connecting the input termination connector and the protector panel and a second trace electrically connecting the protector panel and the output termination, wherein the resistance of the first trace is greater than the resistance of the second trace.

2. The building entrance protector of claim 1 wherein said input termination connector is mounted on said printed circuit board.

3. The building entrance protector of claim 1 wherein said output termination connector is mounted on said printed circuit board.

4. The building entrance protector of claim 1 wherein said protector panel is mounted on said printed circuit board.

5. The building entrance protector of claim 1 wherein said protector panel comprises a surge protector.

6. The building entrance protector of claim 1 wherein a cross-section of said second trace is greater than a cross section of said first trace.

7. The building entrance protector of claim 6 wherein the width of said second trace is greater than the width of said first trace.

8. The building entrance protector of claim 1 wherein said input termination connector, said output termination connector and said protector panel are mounted on said printed circuit board.

9. The building entrance protector of claim 1 including a housing, wherein the printed circuit board is mounted on a first side of the housing and the input termination connector, output termination connector and protector panel are mounted on a second side of the housing.

10. A method of connecting wire entering a building from outside the building with wire inside the building comprising:
providing a printed circuit board;
electrically connecting an input termination connector to the printed circuit board;
electrically connecting an output termination connector to the printed circuit board;
electrically connecting a protector panel to the printed circuit board;
forming a first trace on the printed circuit board having a first resistance electrically connecting the input termination connector to the protector panel; and
forming a second trace on the printed circuit board having a second resistance less than the first resistance electrically connecting the protector panel to the output termination connector.

11. The method of claim 10 including connecting the wire entering the building to the input termination connector.

12. The method of claim 11 including connecting the wire inside the building to the output termination connector.

13. The method of claim 10 including mounting the input termination connector and output termination connector and protector panel on the printed circuit board.

14. The method of claim 10 wherein said forming a second trace on the printed circuit board having a second resistance less than the first resistance comprises forming a second trace having a cross-section greater than a cross section of the first trace.

15. A building entrance protector for interconnecting wire entering a building from outside the building with wire inside the building, the building entrance protector comprising:
a printed circuit board;
a protector panel mounted on and electrically connected to the printed circuit board;
an input termination connector connectable to the wire entering the building and electrically connected to the protector panel by a fusible link formed on the printed circuit board; and
an output termination connector connectable to the wire inside the building and electrically connected to the printed circuit board.

16. The building entrance protector of claim 15 wherein said fusible link comprises a trace formed on the printed circuit board.

17. The building entrance protector of claim 16 wherein said fusible link comprises a first trace formed on said printed circuit board and including a second trace connecting said output termination connector to said protector panel, wherein a width of said first trace is less than a width of said second trace.

18. A building entrance protector for interconnecting wire entering a building from outside the building with wire inside the building, the building entrance protector comprising:
a housing having a first group of openings comprising input openings, a second group of openings comprising output openings and a third group of openings comprising protector openings;
a printed circuit board having a first group of vias comprising input vias, a second group of vias comprising output vias and a third group of vias comprising protector vias; and
a surge protector having a plurality of pins extending though said third group of openings and being electrically connected to said third group of vias;
the printed circuit board further including a first set of traces electrically connecting the first group of vias to the third group of vias and a second set of traces electrically connecting the third group of vias to the second set of vias, wherein the electrical resistance of the traces in the first set of traces is greater than the electrical resistance of the traces of the second set of traces.

19. The building entrance protector of claim 18 further including an input termination connector having input pins electrically connected to said input vias and an output termination connector having output pins electrically connected to said output vias.

20. The building entrance protector of claim 18 wherein said first group of openings is aligned with said first group of vias, said second group of openings is aligned with said second group of vias and said third group of openings is aligned with said third group of vias.
